(19) United States
(12) Patent Application Publication
(10) Pub. No.: US 2012/0281353 A1
(43) Pub. Date: Nov. 8, 2012

(54) COMPUTER POWER SYSTEM

(75) Inventors: TE-MING CHANG, Tu-Cheng (TW); YU-CHI TSAI, Tu-Cheng (TW)

(73) Assignee: HON HAI PRECISION INDUSTRY CO., LTD., Tu-Cheng (TW)

(21) Appl. No.: 13/245,889

(22) Filed: Sep. 27, 2011

(30) Foreign Application Priority Data
May 4, 2011 (TW) 100115583

(51) Int. Cl. G06F 1/20; G06F 1/18

(52) U.S. Cl. 361/679.46; 361/679.02

(57) ABSTRACT

A computer power system includes a first power supply unit having a first output end, and a second power supply unit stacked on the first power supply unit and having a second output end adjacent to the first output end, a first power interface board electrically connected to the first output end and perpendicular to an end surface of the first output end, a second power interface board electrically connected to the second output end and perpendicular to an end surface of the second output end, and an electrical connection device. The electrical connection device connects the first power interface board and the second power interface board, such that the first power supply unit and the second power supply unit are electrically connected in parallel to the second power interface board.

### BACKGROUND

1. Technical Field

The present disclosure relates to a computer power system, and particularly, to a computer power system having better heat dissipation efficiency.

2. Description of Related Art

A personal computer generally includes a computer power system to supply electrical power to a motherboard of the personal computer. The computer power system includes a plurality of power supply units to supply electrical power to electric elements on a motherboard. Referring to FIG. 1, a computer power system 100 includes two power supply units 10 laminated to each other and a power interface board 12 for electrically connecting the two power supply units 10 in parallel. Each of the two power supply units 10 is electrically connected to the power interface board 12 by a first power connector 14. The power interface board 12 is electrically connected to a power distribution board (not shown) by a second power connector 16, such that electrical power can be distributed to the electric elements.

However, for the sake of compactness, the power interface board 12 covers one end of each of the two power supply units 10. Accordingly, it is hard to dissipate heat generated by the two power supply units 10, and the heat dissipation efficiency is low.

Therefore, what is needed is a new computer power system that can overcome the described limitations.

### BRIEF DESCRIPTION OF THE DRAWINGS

FIG. 1 is an isometric view of a computer power system of a related art.

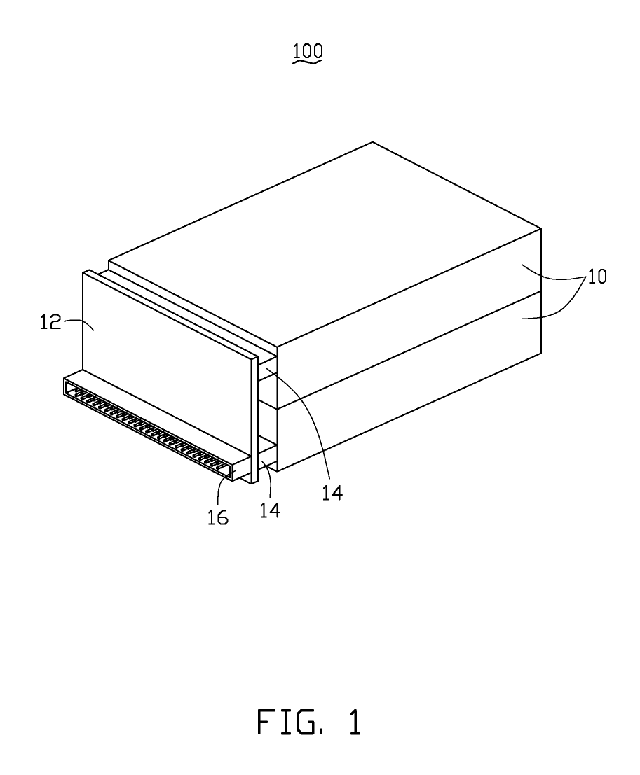

FIG. 2 is an exploded, isometric view of a computer power system according to a first embodiment.

FIG. 3 is a assembled, isometric view of the computer power system of FIG. 2.

FIG. 4 is a side view of the computer power system of FIG. 2.

FIG. 5 is a schematic circuit view of the computer power system of FIG. 2.

FIG. 6 is a side view of a computer power system according to a second embodiment.

FIG. 7 is a schematic circuit view of the computer power system of FIG. 6.

### DETAILED DESCRIPTION

Embodiments will be described in detail with reference to the drawings.

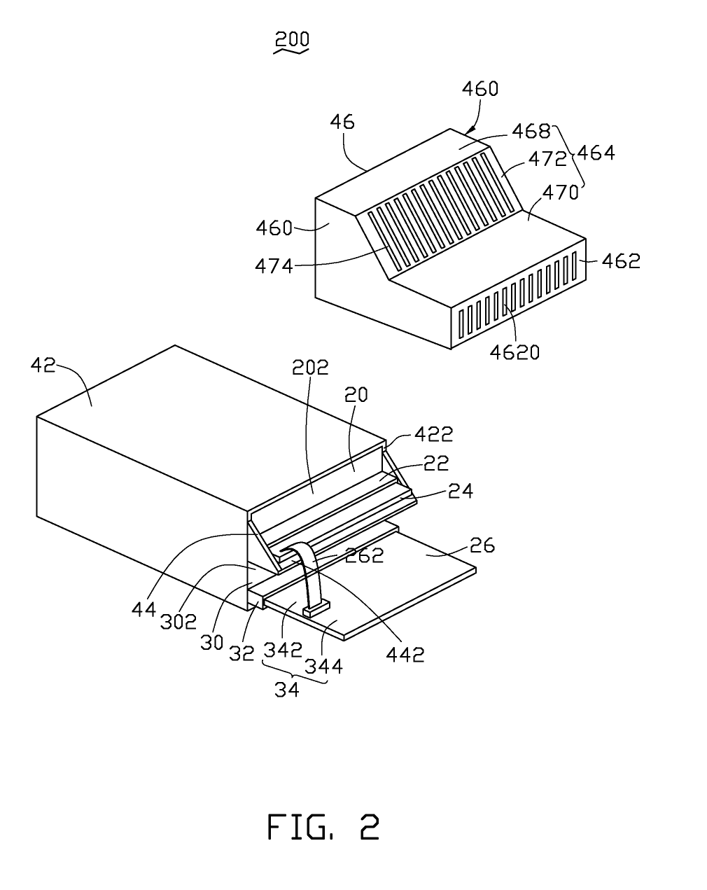

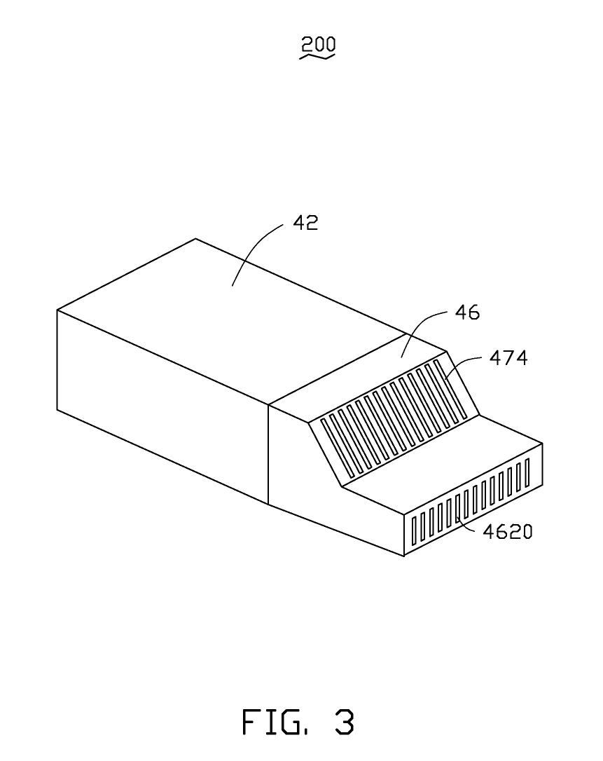

Referring to FIGS. 2 through 4, a computer power system 200, in accordance with a first embodiment, is shown. The computer power system 200 includes a first power supply unit 20, a second power supply unit 30, a first power connector 22, a second power connector 32, a third power connector 26, a first power interface board 24, and a second power interface board 34.

The first power supply unit 20 is laminated to the second power supply unit 30, and they are configured for respectively supplying electric power. The first power supply unit 20 includes a first output end 202. The second power supply unit 30 includes a second output end 302 adjacent to the first output end 202. In the present embodiment, the first output end 202 is coplanar with the second output end 302.

The first power connector 22 is configured for electrically connecting the first power supply unit 20 to the first power interface board 24, and is sandwiched between the first power supply unit 20 and the first power interface board 24. The second power connector 32 is configured for electrically connecting the second power supply unit 30 to the second power interface board 34, and is sandwiched between the second power supply unit 30 and the second power interface board 34. In the present embodiment, the first power connector 22 is electrically connected to the first power supply unit 20 by pin header and female header (not shown), and the second power connector 32 is electrically connected to the second power supply unit 30 by pin header and female header.

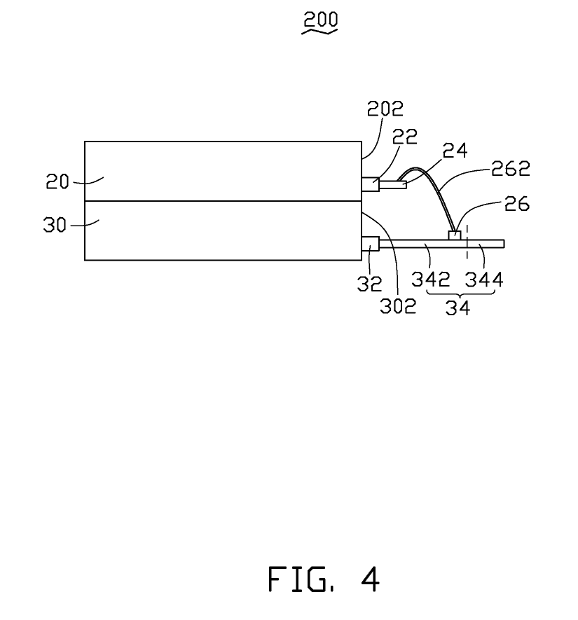

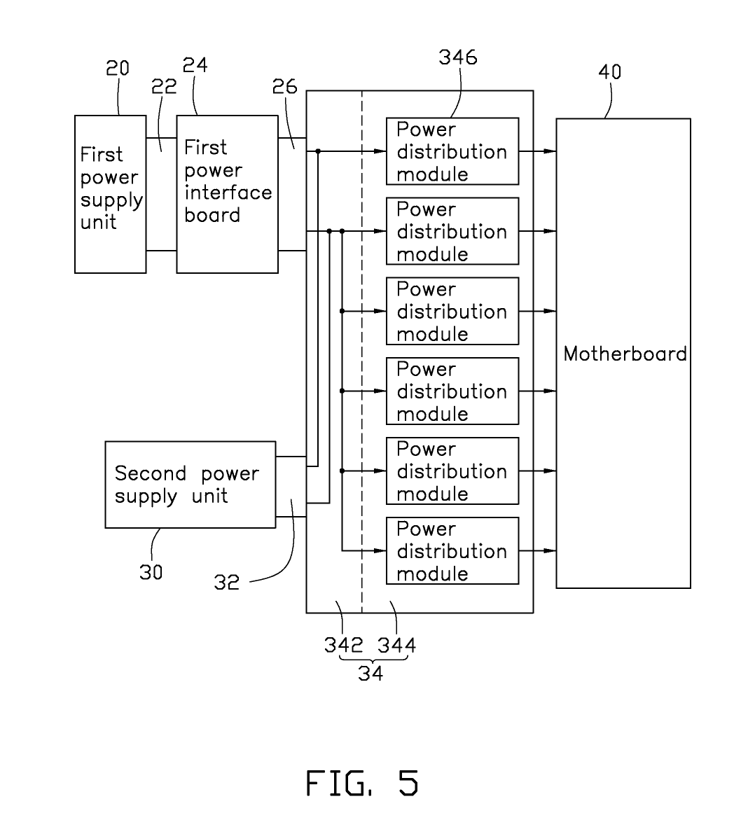

The second power interface board 34 includes a power interface portion 342 and a power distribution portion 344 adjacent to the power interface portion 342. The power interface portion 342 and the power distribution portion 344 are separated from each other (shown by a dotted line in FIGS. 4 and 5). In other words, the power interface portion 342 is sandwiched between the second power connector 32 and the power distribution portion 344.

The third power connector 26 is fixed and electrically connected to the end of the power interface portion 342, which is away from the second power connector 32. The third power connector 26 is electrically connected to the first power connector 22 via an electrical connection device 262, and the electrical connection device 262 is fixed and electrically connected to the end of the first power interface board 24, which is away from the first power connector 22.

In the present embodiment, the electrical connection device 262 is a cable. One end of the electrical connection device 262 is directly electrically connected to the first power interface board 24, and the other end of the electrical connection device 262 is electrically connected to the third power connector 26 by pin header and female header.

In the present embodiment, the end surface of the first output end 202 of the first power supply unit 20 is perpendicular to the first power interface board 24, and the end surface of the second output end 302 of the second power supply unit 30 is perpendicular to the second power interface board 34.

The computer power system 200 also includes a receiving portion 42, a support shelf 44, and a protection cover 46.

The receiving portion 42 is configured for receiving the first and second power supply units 20 and 30. The receiving portion 42 is a substantially hollow cuboid, and the first and second power supply units 20 and 30 are fixed in the receiving portion 42. The receiving portion 42 includes an opening 422. The first output end 202 and the second output end 302 are exposed therethrough.

The support shelf 44 is fixed on an outer sidewall of the receiving portion 42, and is adjacent to the opening 422. The support shelf 44 includes a support plate 442 perpendicular to the end surface of the first output end 202. The first power interface board 24 is fixed on the support plate 442.

The protection cover 46 includes two opposite first sidewalls 460, a second sidewall 462 sandwiched between the two opposite first sidewalls 460, and a stepped top 464 sandwiched between the two opposite first sidewalls 460.

The two opposite first sidewalls 460 are arranged at the opposite sides of the first power interface board 24, and are perpendicular to the first power interface board 24.

The second sidewall 462 is adjacent to the side of the second power interface board 34, which is away from the second power supply unit 30, and is perpendicular to the second power interface board 34. A plurality of parallel first ventilation openings 4620 is defined in the second sidewall 462 for allowing an airflow.

The stepped top 464 includes a first covering portion 468, a second covering portion 470, and a ventilation portion 472 connected between the first covering portion 468 and the second covering portion 470.

The first covering portion 468 is located at the side of the first power interface board 24, which is away from the second power interface board 34, and is opposite to the first power interface board 24.

The second covering portion 470 is opposite to the second power interface board 34, and the vertical distance between the second covering portion 470 and the second power interface board 34 is less than the vertical distance between the first power interface board 24 and the second power interface board 34.

The two sides of the ventilation portion 472 are respectively connected to the first and second covering portion 468 and 470, such that the stepped top 464 is a stepped structure. A plurality of parallel second ventilation openings 474 is defined in the ventilation portion 472 for allowing an airflow. In the present embodiment, the first ventilation openings 474 are inclined relative to the first power interface board 24 for the better dissipation of heat from the first power interface board 24. When the protection cover 46 is used, the protection cover 46 is fixed on a computer case (not shown) with the computer power system 200 fixed therein.

Referring also to FIG. 5, the first power supply unit 20 is electrically connected to the power interface portion 342 by the first power connector 22, the first power interface board 24, and the second power connector 26, in that order. The second power supply unit 30 is electrically connected to the power interface portion 342 by the second power connector 32. Inner wires (not shown) of the power interface portion 342 electrically connect the first and second power supply units 20 and 30 in parallel, and the wires connected in parallel are electrically connected to the power distribution portion 344. The power distribution portion 344 includes a plurality of power distribution modules 346. The power distribution modules 346 are electrically connected to a plurality of elements (such as the CPU and fan) (not shown) of a motherboard 40, such that these elements can work normally.

In other embodiments, the presence of the third power connector 26 is not crucial. In such a case, the two opposite ends of the electrical connection device 262 are directly soldered to the first power interface board 24 and the second power interface board 34.

In the present embodiment, the first power interface board 24 and the second power interface board 34 are perpendicular to the end surfaces of the first output end 202 and the second output end 302, such that the first output end 202 is exposed. Accordingly, air can freely enter or exit the first and second power supply units 20 and 30, heat dissipation from the first and second power supply units 20 and 30 can be improved, and the first and second power supply units 20 and 30 will be more stable.

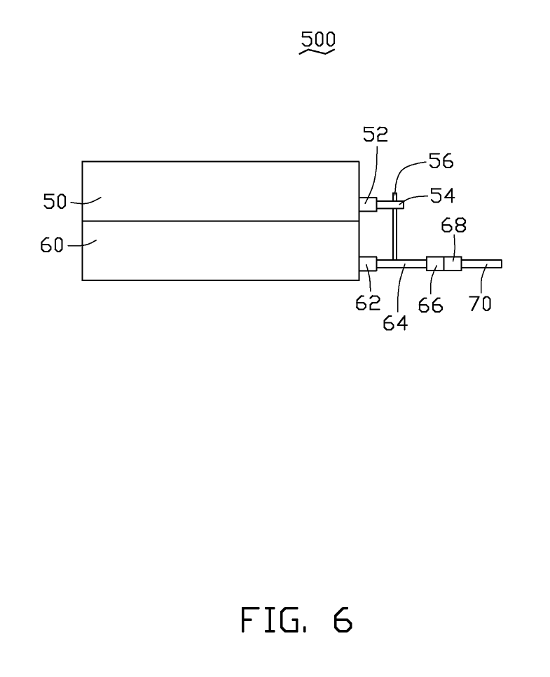

Referring to FIG. 6, a computer power system 200, in accordance with a second embodiment, is similar to the computer power system 100 of the first embodiment. The computer power system 200 includes a first power supply unit 50, a second power supply unit 60, a first power connector 52, a second power connector 62, a third power connector 66, a fourth power connector 68, a first power interface board 54, a second power interface board 64, an electrical connection device 56, and a power distribution board 70.

In the present embodiment, the structures and arrangements of the first power supply unit 50, the second power supply unit 60, the first power connector 52, and the second power connector 62 are identical to that their counterparts in the first embodiment.

The first power connector 52 is fixed and electrically connected to the first power interface board 54, and the connection between the first power connector 52 and the first power interface board 54 is identical to the connection between the first power connector 22 and the power interface board 24. The second power connector 62 is fixed and electrically connected to the second power interface board 64, and the connection between the second power connector 62 and the second power interface board 64 is identical to the connection between the first power connector 22 and the power interface board 24.

The third power connector 66 is fixed and electrically connected to the end of the second power interface board 64, which is opposite to the second power connector 62. The fourth power connector 68 is fixed and electrically connected to an end of the power distribution board 70. The third power connector 66 is electrically connected to the fourth power connector 68 via pin header and female header. In the present embodiment, the power distribution board 70 is parallel with the first and second power interface boards 54 and 64.

In the present embodiment, the electrical connection device 56 is a pin header, and includes a plurality of needles (not labeled). The needles connect the first and second power interface boards 54 and 64. The electrical connection device 56 is perpendicular to the first and second power interface boards 54 and 64, and is adjacent to the ends of the first and second power interface boards 54 and 64, which are away from the first and second power supply units 50 and 60. There is a gap between every two neighboring needles to allow the passage of air.

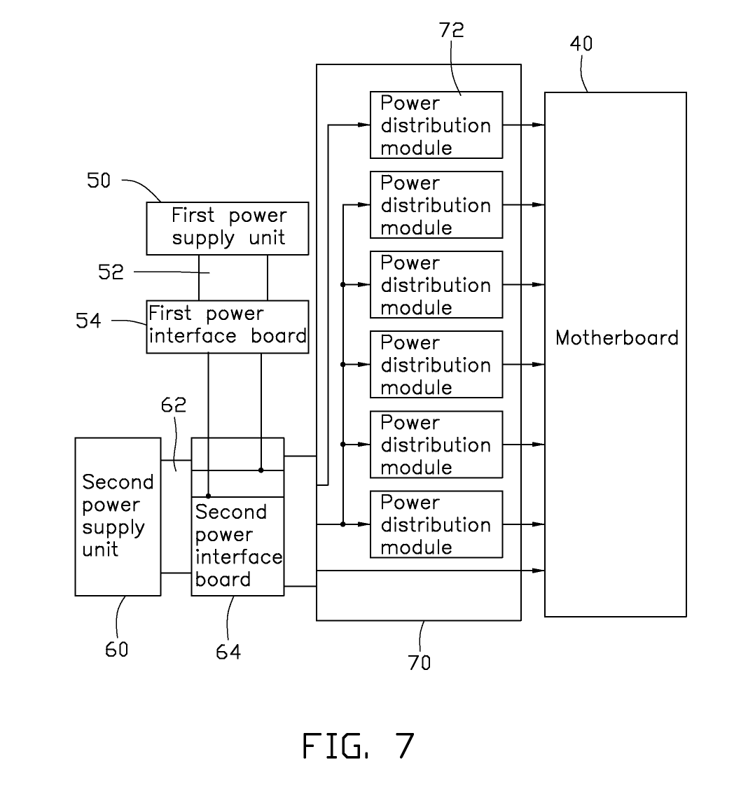

Referring also to FIG. 7, the first and second power supply units 50 and 60 are electrically connected to the first and second power interface boards 54 and 64. The first power interface board 54 is electrically connected to the second power interface board 64 by the electrical connection device 56, such that the first power supply unit 50 is electrically connected to the second power supply unit 60 in parallel. After the first and second power supply units 50 and 60 have been electrically connected to each other, the electrical connection between the third and fourth power connectors 66 and 68 also connects the first and second power supply units 50 and 60 to the power distribution 70.

The power distribution board 70 includes a plurality of power distribution modules 72. The power distribution modules 72 are electrically connected to a plurality of elements (not shown) of a motherboard 40.

In other embodiments, the presence of the third and fourth power connectors 66 and 68 is not crucial. In such a case, the second power interface board 64 and the power distribution board 70 are on the same circuit board.

In the present embodiment, the first and second power interface boards 54 and 64 are perpendicular to the end surfaces of the first and second power supply units 50 and 60, such that the ends of the first and second power supply units 50 and 60 are exposed. Accordingly, air can pass freely through the first and second power supply units 50 and 60, the heat dissipation of the first and second power supply units 50 and 60 is improved, and the first and second power supply units 50 and 60 will be more stable. In addition, the first power interface board 54 is electrically connected to the second power interface board 64 by the electrical connection device 56, and there is a gap between every two neighboring needles of the electrical connection device 56. Accordingly, the airflow through the first and second power supply units 50 and 60 is unrestricted, and the heat dissipation of the first and second power supply units 50 and 60 is improved.

While certain embodiments have been described and exemplified above, various other embodiments will be apparent from the foregoing disclosure to those skilled in the art. The disclosure is not limited to the particular embodiments described and exemplified but is capable of considerable variation and modification without departure from the scope and spirit of the appended claims.

What is claimed is:

1. A computer power system comprising:
a first power supply unit, the first power supply unit comprising a first output end;
a second power supply unit stacked on the first power supply unit, the second power supply unit comprising a second output end adjacent to the first output end;
a first power interface board, the first power interface board being electrically connected to the first output end, and being perpendicular to an end surface of the first output end;
a second power interface board, the second power interface board being electrically connected to the second output end, and being perpendicular to an end surface of the second output end, and
an electrical connection device, the electrical connection device being electrically connecting the first power interface board to the second power interface board, such that the first power supply unit and the second power supply unit are electrically connected to the second power interface board.

2. The computer power system of claim 1, further comprising a power distribution board electrically connected to the second interface board.

3. The computer power system of claim 2, wherein the power distribution board is electrically connected to the second interface board by pin header and female header.

4. The computer power system of claim 2, wherein the power distribution board and the second interface board are on a same circuit board.

5. The computer power system of claim 1, wherein the electrical connection device comprises a cable, one end of the cable is directly electrically connected to the first power interface board, and the other end of the cable is electrically connected to the second interface board.

6. The computer power system of claim 1, wherein the electrical connection device comprises a pin header, opposite ends of the pin header are electrically connected to the first power interface board and the second power interface, respectively.

7. The computer power system of claim 1, further comprising a receiving portion receiving the first power supply unit and the second power supply unit, the receiving portion defining an opening with the first output end and the second output end exposed out of the receiving portion through the opening.

8. The computer power system of claim 7, further comprising a support shelf fixed on the receiving portion and adjacent to the opening, the support shelf comprising a support plate perpendicular to the end surface of the first output end and supporting the first power interface board.

9. The computer power system of claim 7, further comprising a protection cover covering the opening of the receiving portion, the first power interface board, the second power interface board, and the power distribution board, the protection cover comprising a plurality of ventilation opening for allowing airflow to enter or exit the protection cover.

10. A computer power system comprising:
a first power supply unit, the first power supply unit comprising a first output end;
a second power supply unit positioned on the first power supply unit, the second power supply unit comprising a second output end adjacent to the first output end;
a first power interface board, the first power interface board being electrically connected to the first output end, and being perpendicular to an end surface of the first output end;
a second power interface board, the second power interface board comprising a power interface portion, the power interface portion being electrically connected to the second output end, and being perpendicular to an end surface of the second output end, and
an electrical connection device, the electrical connection device being electrically connecting the first power interface board and the power interface portion, such that the first power supply unit and the second power supply unit are electrically connected to the second power interface board.

11. The computer power system of claim 10, wherein the electrical connection device comprises a cable, one end of the cable is directly electrically connected to the first power interface board, and the other end of the cable is electrically connected to the second interface board.

12. The computer power system of claim 10, further comprising a receiving portion receiving the first power supply unit and the second power supply unit, the power receiving portion defining an opening with the first output end and the second output end exposed out of the receiving portion through the opening.

13. The computer power system of claim 12, further comprising a support shelf fixed on the receiving portion and adjacent to the opening, the support shelf comprising a support plate perpendicular to the end surface of the first output end and supporting the first power interface board.

14. The computer power system of claim 12, further comprising a protection cover covering the opening of the receiving portion, the first power interface board and the second power interface board, the protection cover comprising a plurality of ventilation opening for allowing airflow to enter or exit the protection cover.
